(19) United States
(12) Patent Application Publication
(10) Pub. No.: US 2024/0301902 A1
(43) Pub. Date: Sep. 12, 2024

(54) MODULAR PANEL SYSTEM, KIT, AND METHOD

(71) Applicant: Honda Motor Co., Ltd., Tokyo (JP)

(72) Inventors: Satoshi HAYASHI, Wako (JP); Geemay CHIA, Pasadena, CA (US); Brian E. DRESSEL, Worthington, OH (US); So NAKAURA, Wako (JP); Travis W. CANNADY, Marysville, OH (US); Ju-Chia LEE, Pasadena, CA (US)

(21) Appl. No.: 18/181,156

(22) Filed: Mar. 9, 2023

(51) Int. Cl. F16B 5/06

(52) U.S. Cl. CPC F16B 5/0607; F16B 21/065; F16B 2005/0678

(57) ABSTRACT

A modular panel system, kit and method includes a first panel and a second panel removably connected to the first panel. Each of the first and second panels includes end edge portions spaced apart from one another to define a panel length, and lateral edge portions spaced apart from one another to define a panel width with each of the lateral edge portions extending from one of the end edge portions to the other of the end edge portions. The panel length and panel width of the second panel are, respectively, the same as the panel length and panel width of the first panel. The first and second panels are configured to be removably coupled to one another by having respective edge portions of each of the first and second panels arranged longitudinally adjacent to one another and removably coupled together.

### BACKGROUND

A variety of collapsible panel systems are known. Also a variety of collapsible furniture structures are known. Nonetheless, there remains a need for easily transportable collapsible structures, including panel systems that are collapsible and configurable into various useful structures, such as furniture. In particular, disadvantages of known collapsible furniture and panel systems includes the following: difficult to assemble and disassemble, difficult to transport, configurable in only a limited configuration or a few configurations, etc.

### BRIEF DESCRIPTION

According to one aspect, a modular panel system includes a first panel and a second panel removably connected to the first panel. Each of the first and second panels includes end edge portions spaced apart from one another to define a panel length, and lateral edge portions spaced apart from one another to define a panel width with each of the lateral edge portions extending from one of the end edge portions to the other of the end edge portions. The panel length and the panel width of the second panel are, respectively, the same as the panel length and the panel width of the first panel. The first and second panels are configured to be removably coupled to one another by having respective edge portions of each of the first and second panels arranged longitudinally adjacent to one another and removably coupled together.

According to another aspect, a modular panel system kit includes a first panel and a second panel. The first panel is defined by first panel edge portions including first panel end edge portions spaced apart from one another to define a first panel length, and including first panel lateral edge portions spaced apart from one another to define a first panel width and each extending from one of the first panel end edge portions to the other of the first panel end edge portions. The second panel is defined by second panel edge portions including second panel end edge portions spaced apart from one another to define a second panel length, and including second panel lateral edge portions spaced apart from one another to define a second panel width and each extending from one of the second panel end edge portions to the other of the second panel end edge portions. The second panel length is the same as the first panel length and the second panel width is the same as the first panel width. Also, the first and second panels are configured to be removably coupled to one another by having one of the first panel edge portions disposed longitudinally adjacent one of the second panel edge portions and removably coupled thereto.

According to a further aspect, a modular panel method includes providing a first panel defined by first panel edge portions including first panel end edge portions spaced apart from one another to define a first panel length, and including a first panel lateral edge portions spaced part from one another to define a first panel width and each extending from one of the first panel end edge portions to the other of the first panel end edge portions. The method further includes providing a second panel defined by second panel edge portions including second panel end edge portions spaced apart from one another to define a second panel length, and including second panel lateral edge portions spaced apart from one another to define a second panel width and each extending from one of the second panel end edge portions to the other of the second panel end edge portions. The second panel length is the same as the first panel length and the second panel width is the same as the first panel width. The method further includes removably coupling the first panel and the second panel together by having one of the first panel edge portions disposed longitudinally adjacent one of the second panel edge portions and removably coupling the first panel edge portion and the second panel edge portion together.

### BRIEF DESCRIPTION OF THE DRAWINGS

FIG. 1 is a schematic perspective view of a modular panel system shown in an assembled state in a shade chair configuration according to one aspect of the present disclosure.

FIG. 2 is a schematic front elevation view of the modular panel system of FIG. 1 also shown in the assembled state in the shade chair configuration.

FIG. 3 is a schematic plan view of one panel of the modular panel system of FIGS. 1 and 2.

FIG. 4 is a perspective view of four panels of the modular panel system of FIGS. 1 and 2 shown in a disassembled state in a stacked configuration.

FIGS. 5A and 5B are schematic perspective views of coupling devices that can be used or included with the modular panel system of FIG. 1.

FIG. 6 is a schematic perspective view of the modular panel system of FIG. 1 shown in the assembled state in a lounge chair configuration.

FIG. 7 is a schematic perspective view of the modular panel system of FIG. 1 shown in an assembled state in a table configuration using only a single panel of the modular panel system.

FIG. 8 is a schematic perspective view showing the modular panel system in the disassembled state in the stacked configuration wherein the stacked panels are loaded into the rear cargo area of a vehicle.

FIG. 9 is a process flow diagram of a modular panel method according to one aspect of the present disclosure.

### DETAILED DESCRIPTION

It should, of course, be understood that the description and drawings herein are merely illustrative and that various modifications and changes can be made in the structures disclosed without departing from the present disclosure. Spatially relative terms may be used to describe an element and/or features relationship to another element(s) and/or feature(s) as, for example, illustrated in the figures. Moreover, any term of degree used herein, such as “substantially” and “approximately” means a reasonable amount of deviation of the modified word is contemplated such that the end result is not significantly changed.

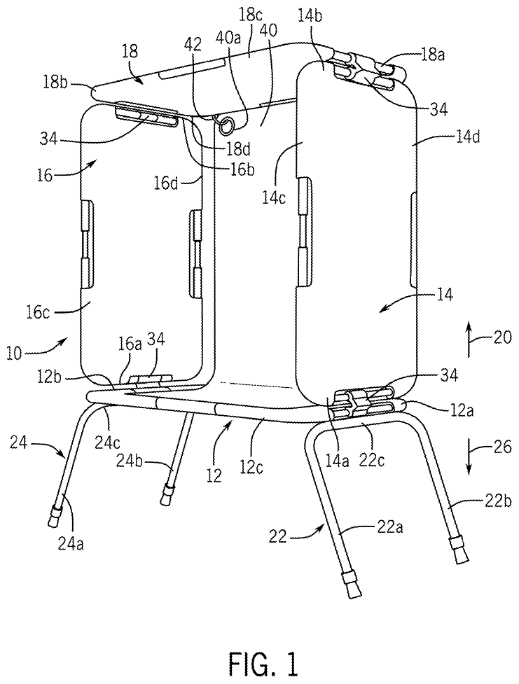

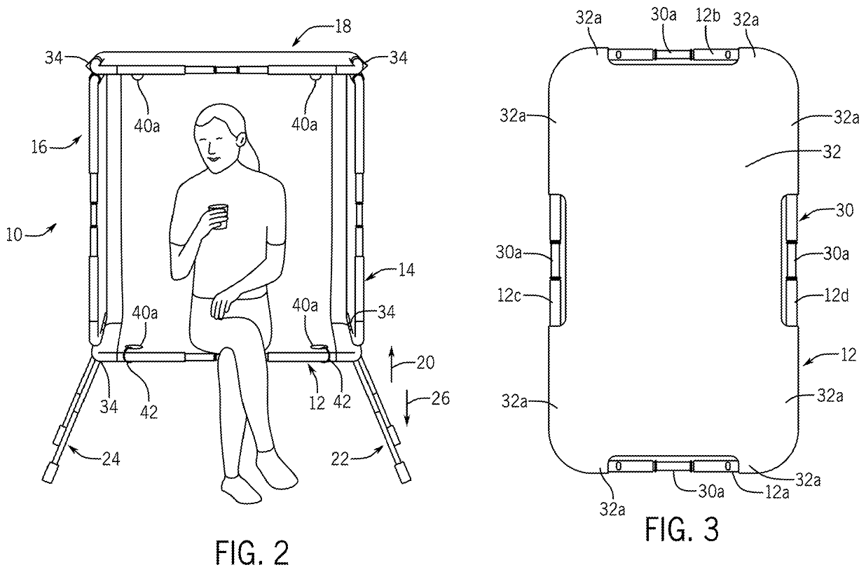

Referring now to the drawings, wherein like numerals refer to like parts throughout the several views, FIGS. 1 and 2 illustrate a modular panel system or kit 10 according to one embodiment of the present disclosure. More particularly, the modular panel system 10 of the illustrated embodiment is shown in an assembled state and particularly in a shade chair configuration. The modular panel system 10 of the illustrated embodiment includes a first panel 12, a second panel 14, a third panel 16, and a fourth panel 18. The second panel 14 is removably connected to the first panel 12 at a lower end thereof (i.e., at end edge portion 14a) and likewise the third panel 16 is removably connected to the first panel 12 at a lower end thereof (i.e., at the end edge portion 16a) but in laterally spaced relation relative to the second panel 14. The fourth panel 18 is removably connected to the second and third panels 14, 16 at respective upper ends thereof (i.e., end edge portions 14b, 16b) in spaced relation relative to the first panel 12.

As shown, in the assembled state in the shade chair configuration, the first panel 12 provides an elevated seating platform, such as for a person P as shown in FIG. 2 to sit. The other panels 14, 16, 18 can provide at least one of shade, privacy or an enclosure effect to the first panel 12. The modular panel system 10 of the illustrated embodiment is shown including four panels, i.e., panels 12, 14, 16, 18. However, it is to be understood by those skilled in the art that fewer than four panels could be included or more than four panels could be included as part of the modular panel system 10 and these could provide other configurations in the assembled state than the illustrated shade chair.

More particularly, each of the panels 12, 14, 16, 18 includes edge portions, particularly including end edge portions (e.g., end edge portions 12a, 12b, 14a, 14b, 16a, 16b, 18a, 18b) spaced apart from one another to define a panel length for a particular panel and lateral edge portions (e.g., lateral edge portions 12c, 12d, 14c, 14d, 16c, 16d, 18c, 18d) spaced apart from one another to define a width for the particular panel with each lateral edge portion extending from one of the end edge portions to the other of the end edge portions of a particular panel. With additional reference to FIG. 3, the first panel 12 is shown and will be described in further detail. It is to be appreciated that details and/or features of the first panel 12 can be the same for the other panels 14, 16, 18. Accordingly, in one embodiment, the panels 12, 14, 16, 18 can be identical to one another, though this is not required. Specifically, the first panel 12 can include edge portions 12a, 12b, 12c and 12d that include end edge portions 12a, 12b spaced apart from one another to define a panel length for the first panel 12 (i.e., first panel length), and lateral edge portions 12c, 12d spaced apart from one another to define a panel width for the first panel 12 (i.e., first panel width) with each of the lateral edge portions 12c, 12d extending from one of the end edge portions 12a or 12b (e.g., end edge portion 12a) to the other of the end edge portions 12a or 12b (e.g., end edge portion 12b).

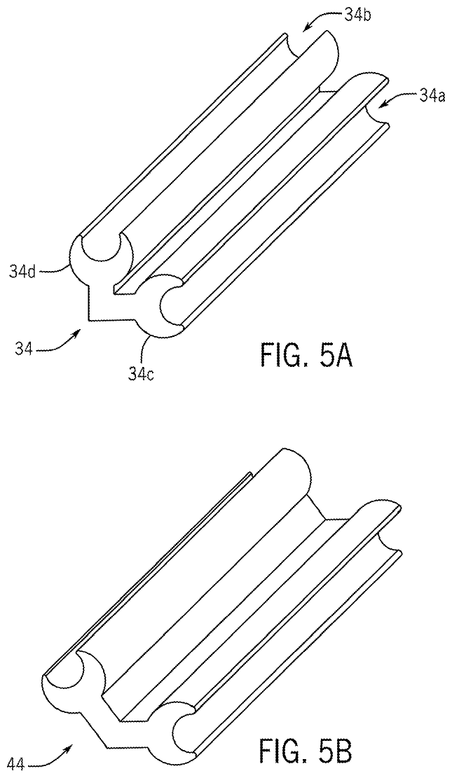

In the illustrated embodiment, the second panel 14 can be the same as the first panel 12. Accordingly, the second panel 14 can likewise include end edge portions 14a, 14b, 14c, 14d, including end edge portions 14a, 14b spaced apart from one another to define a panel length of the second panel 14 (i.e., second panel length), and lateral edge portions 14c, 14d spaced apart from one another to define a panel width of the second panel 14 (i.e., second panel width) with each of the lateral edge portions 14c, 14d extending from one of the end edge portions 14a or 14b (e.g., end edge portion 14a) to the other of the end edge portions 14a or 14b (e.g., end edge portion 14b). Since the panels 12 and 14 are identical to one another in the illustrated embodiment, the second panel length and second panel width of the second panel 14 are, respectfully, the same as the first panel length and the first panel width of the first panel 12. As will be described in more detail below, the first and second panels 12, 14 are configured to be removably coupled to one another by having respective edge portions, particularly edge portions 12a and 14a of each of the first and second panels 12, 14, arranged longitudinally adjacent to one another and removably coupled together. This removable coupling can be enabled by a coupling device or member, such as coupling device 34 shown in FIG. 5A, as will be described in more detail below.

As already mentioned, the third and fourth panels 16, 18 can also be identical to the first panel 12. Accordingly, each of these panels 16, 18 includes edge portions, including end edge portions (end edge portions 16a, 16b for the third panel 16 and end edge portions 18a, 18b for the fourth panel 18) spaced apart from one another to define a panel length, and lateral edge portions (lateral edge portions 16c, 16d for the third panel 16 and lateral edge portions 18c, 18d for the fourth panel 18) spaced apart from one another to define a panel width with each of the lateral edge portions extending from one of the end edge portions to the other of the end edge portions. The third panel 16 and the fourth panel 18 are each configured to be removably coupled to the other panels 12, 14, 16, 18. For example, in FIG. 1, end edge portion 16a of the third panel 16 is arranged longitudinally adjacent the end edge portion 12b and removably coupled thereto. End edge portion 16b of the third panel 16 is arranged longitudinally adjacent the end edge portion 18b of the fourth panel 18 and removably coupled thereto. End edge portion 14b is arranged longitudinally adjacent the end edge portion 18a of the fourth panel and removably coupled thereto. In one embodiment, the removable couplings between all panels 12, 14, 16, 18 can be via the coupling device 34 of FIG. 5, though other coupling devices can be used as noted above.

Since the third panel 16 is the same as the first and second panels 12, 14, the panel length and panel width of the third panel 16 are, respectively, the same as the panel length and panel width of the first panel 12 and the second panel 14. Similarly, since the fourth panel is the same in size and shape as the first, second, and third panels 12, 14, 16, the panel length and panel width of the fourth panel 18 are, respectively, the same as the panel length and panel width of each of the first panel 12, the second panel 14, and the third panel 16.

In the assembled configuration of FIGS. 1 and 2, the first, second, third, and fourth panels 12, 14, 16, 18 are specifically orthogonally arranged to form a rectangular structure or configuration, which can be referred to as a shade chair configuration as mentioned above. In particular, the end edge portions of the first, second, third, and fourth panels 12, 14, 16, 18 are secured to one another such that the second and third panels, 14, 16 are spaced apart from one another and are secured to both the first and fourth panels 12, 18 with the first and fourth panels 12, 18 spaced apart from one another. In particular, the second and third panels 14, 16 extend in a first direction illustrated by arrow 20 away from the first panel 12.

In addition, as shown, the modular panel system 10 can include at least one leg attachment member, such as the illustrated leg attachment members 22, 24. In particular, in the illustrated embodiment, the at least one leg attachment member includes two leg attachment members 22, 24. Each of these leg attachment members 22, 24 is removably secured to the first panel 12 at the end edge portions 12a, 12b and extends substantially in a second direction illustrated by arrow 26 away from the first panel 12 that is opposite the first direction represented by arrow 20. As shown, the first leg attachment member 22 can be removably secured to a first one of the end edge portions of the first panel 12, namely the end edge portion 12a, and the second leg attachment member 24 can be secured to a second one of the end edge portions of the first panel 12, namely the end edge portion 12b that is opposite the first end edge portion 12a.

The leg attachment members 22, 24 in the illustrated embodiment are each formed as a U-shaped structure. Accordingly, the first leg attachment member 22 includes leg portions 22a, 22b connected together by an attachment portion 22c. The attachment portion 22c is removably coupled to the end edge portion 12a. Likewise, the second leg attachment member 24 can include leg portions 24a, 24b and an attachment portion 24c removably coupled to the end edge portion 12b. The attachment portions 22c, 24c can be removably coupled to the respective end edge portions 12a, 12b of the first panel 12 through any known removable connection as will be understood and appreciated by those skilled in the art. For example, the leg attachment portions 22c, 24c can include a snap-fit removable coupling, a screw-type coupling, a cam-lock type coupling, etc. (none of which are shown). Additionally, the leg attachment members 22, 24, and particularly the leg portions 22a, 22b, 24a, 24b thereof can be or include telescoping legs so as to be height adjustable. In the assembled state and configuration of FIGS. 1 and 2 (i.e., the shade chair configuration), adjusting the telescoping height of the leg portions 22a, 22b, 24a, 24b can selectively raise and lower a desired height of the panels 12, 14, 16, 18 as might be advantageous when choosing a height for the first panel 12 on which to sit.

With reference now to FIG. 3, the first panel 12 will be described in more detail.

It is to be appreciated that details concerning the first panel 12 are also applicable to the second, third, and fourth panels 14, 16, 18. As shown, the first panel 12 includes a frame 30 that defines the end edge portions 12a, 12b and the lateral edge portions 12c, 12d. The first panel 12 additionally includes a flexible material member 32 tautly secured to the frame 30 at each of the end edge portions 12a, 12b and each of the lateral edge portions 12c, 12d. In the illustrated embodiment, the frame 30 is a tubular frame defining a panel perimeter of the first panel 12. For example, the frame 30 can be a continuous tubular frame extending around an entirety of a parameter of the first panel 12. Optionally, as shown, the frame 30 can include reduced diameter portions 30a, at central locations of each of the end edge portions 12a, 12b, 12c, 12d. These reduced diameter portions 30a can be provided for coupling the first panel 12 to other panels 14, 16, 18. In particular, the reduced diameter portions 30a can allow the removable coupler (e.g., coupler 34) to be smaller in size and/or better integrate with the exterior dimensions of the first panel 12 when coupling to other panels. As shown, in the illustrated embodiment, the flexible material member 32 can include sleeve portions 32a for receiving the tubular frame 30. In the illustrated embodiment, sleeve portions 32a are provided in pairs at each of the edge portions 12a, 12b, 12c, 12d flanking the reduced diameter portions 30a. Of course, as will be appreciated by those skilled in the art, other configurations are contemplated.

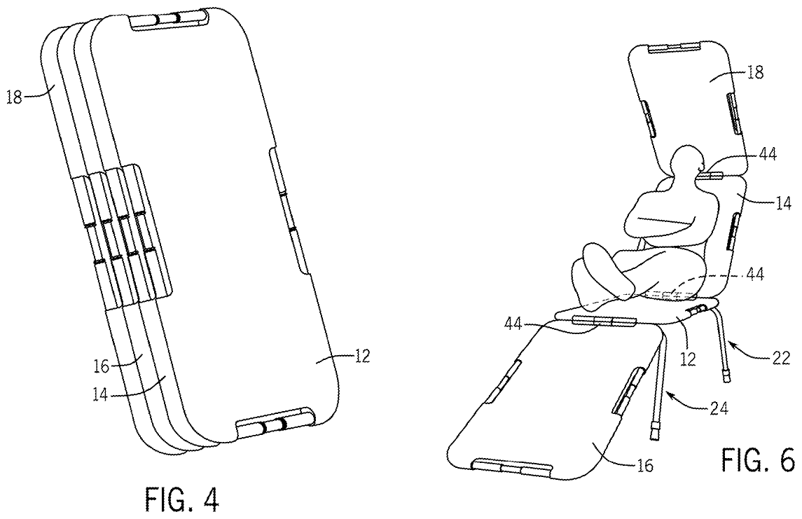

Now, with reference to FIG. 4, the panels 12, 14, 16, 18 are shown in a disassembled state in a stacked configuration. In this stacked configuration, and in part due to the panels 12, 14, 16, 18 being all of the same size, the modular panel system 10 is easily transportable. For example, with reference to FIG. 8, the panels 12, 14, 16, 18 in the stacked configuration can be easily transported in the rear cargo area of a vehicle V.

With reference now to FIGS. 5A and 5B, the modular panel system 10 can further include a coupling device, such as coupling device 34 shown in FIG. 5, for removably coupling the panels 12, 14, 16, 18 to one another. For example, as shown in FIGS. 1 and 2, the first and second panels 12a, 12b are coupled together at the respective end edges 12a, 14a via the coupling device 34 to one another at its desired relative angle. Likewise, additional coupling devices 34 can be used to coupled the panels 16 and 18 to one another and to the first and second panels 12, 14. Accordingly, a plurality of coupling devices 34 can be employed to removably couple the panels 12, 14, 16, 18 together. In the embodiment illustrated in FIGS. 1 and 2, coupling devices 34 are used to couple adjacent panels 12, 14, 16, 18 together in the assembled state and shade chair configuration. As shown in FIG. 5A, the coupling device 34 can be an integrally formed coupling clip having clip recesses 34a, 34b for removably receiving the frame 30 of the panels 12, 14, 16, 18, and particularly the reduced diameter portions 30a of the frame 30.

In particular, the clip recesses 34a, 34b of the coupling device 34 can be respectively provided by clip recess structures 34c, 34d, which are integrally connected and formed. As shown, the clip recess structures 34c, 34d can be oriented perpendicular to one another so that panels 12, 14, 16, 18 can be oriented orthogonally or perpendicular relative to one another when removably connected together (e.g., for the shade chair configuration of FIGS. 1 and 2) by the coupling devices 34. Specifically, the coupling device 34 of FIG. 5A has a fixed angle between the clip recess structures 34c, 34d so that when coupling panels 12, 14, 16, 18 together, the panels are coupled relative to one another at a predefined and nonadjustable relative angle, such as perpendicular to one another. Of course, as will be appreciated and understood by those skilled in the art, other coupling devices can be used in lieu of the illustrated coupling device 34. For example, such other coupling devices could include the provision of a hinged connection between the panels so as to be angularly adjustable. In an alternate embodiment, the coupling devices 34 can be replaced with one of the coupling devices described in commonly owned U.S. patent application Ser. No. ______, entitled “REMOVABLE COUPLING DEVICE AND METHOD FOR COUPLING PANELS” (Attorney Docket No. HRA-53743) that is filed concurrent with the subject application on Mar. 9, 2023, or commonly owned U.S. patent application Ser. No. ______, entitled “COUPLING DEVICE AND METHOD FOR COUPLING PANELS” (Attorney Docket No. HRA-53744) that is filed concurrent with the subject application on Mar. 9, 2023, both expressly incorporated herein in their entireties by reference.

When the modular panel system 10 is deployed in the assembled state in the shade seat configuration shown in FIG. 1, and edge portions of the panels 12, 14, 16, 18, such as end edge portions 12a, 12b, 12c, 12d for the first panel 12 and end edge portions 14a, 14b, 14c, 14d for the second panel 14, are removably secured to one another at perpendicular angles relative to one another. Accordingly, the second panel 14 is removably coupled to the first panel 12 by coupling device 34, which removably couples the end edge portion 12a to the end edge portion 14a of the second panel. In a like manner, another coupling device 34 connects the third panel to the first panel 12 via adjacent longitudinal positioning of end edge portions 12b, 16 of the panels 12 and 16. Additional coupling devices 34 are used to removably couple the fourth panel 18 to the second and third panels 14, 16 in a like manner as shown.

In the shade chair configuration of FIGS. 1 and 2, the modular panel system 10 can further include a flexible coupling material member 40. As shown the flexible coupling material member 40 can be coupled to a front one of the lateral edge portions 12c or 12d of the first panel 12, particularly lateral edge portion 12c in FIGS. 1 and 2, and is coupled to a rear one of the lateral edge portions 18c or 18d of the fourth panel 18, particularly lateral edge portion 18d in FIGS. 1 and 2. By this arrangement, the flexible coupling material member 40 can provide a seat back for the modular panel system 10 as well as a cushioning effect above the first panel 12. That is, as shown in FIG. 2, when a person is seated, the flexible coupling material member 40 can provide a seat back for this person and can additionally be partially spaced apart from the first panel 12, particularly adjacent the lateral edge portion 12d of the first panel 12. For removably coupling the flexible coupling material member 40 to the panels 12 and 18, any known removable connecting device can be used, such as a carabiner clip, bungee tie down, etc. For example, the flexible coupling material member 40 can include securing apertures 40a located at respective corners of the flexible coupling material member 40 and clips or other removable connecting devices 42 can be used to connect the flexible coupling material member 40 to the panels 12, 14, 16, 18 via the clips 42 and the securing apertures 40a.

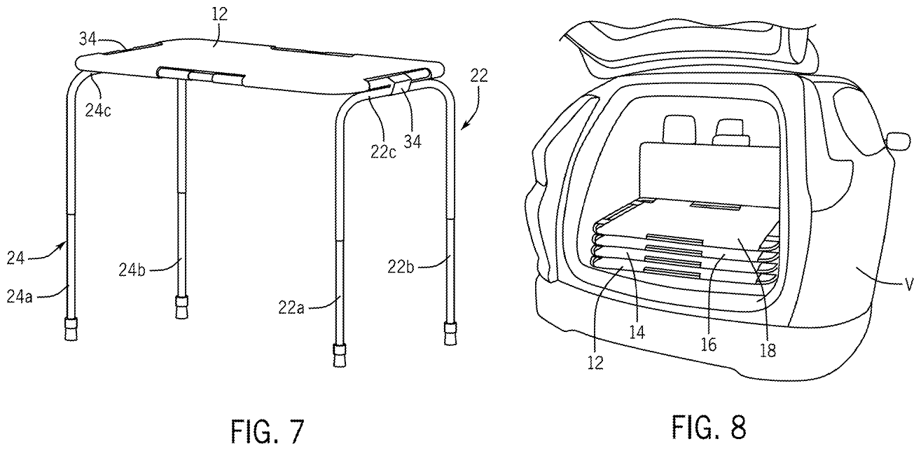

With reference to FIGS. 6 and 7, other configurations for the modular panel system 10 when deployed in the assembled state are illustrated. For example, in FIG. 6, the modular panel system 10 is shown in an assembled state in a lounge chair configuration is provided. In many respects, this assembled state is similar to that shown in FIGS. 1 and 2 except that the third panel 16 is decoupled from the fourth panel 18. Also, the relative angular positions of the panels relative to one another are different. For example, the second panel 14 is disposed at an obtuse angle relative to the first panel 12 so as to provide a reclined surface for a person sitting thereon. Similarly, the third panel 16 is also provided at an obtuse angle, but an angle greater than 180°, to provide a downward angled panel for a person's legs and feet. Still further, the fourth panel 18 is angularly disposed relative to the second panel 14 so as to provide a shading effect for a person sitting thereon. The coupling devices 34 of FIGS. 1 and 2 can be replaced by angular coupling devices 44 (or some other functionally similar coupling device) such as shown in FIG. 5B. These coupling devices 44 provide fixed non-adjustable angular positions for panels 12, 14, 16, 18 connected thereby similar to the coupling devices 34 of FIG. 5a but with differing relative angles. Accordingly, in FIG. 6, the fourth panel 18 is removably connected to only the second panel 14 at an end edge portion 14b of the second panel 14 that is spaced apart from the first panel 12.

With reference now to FIG. 7, a further configuration for the modular panel system 10 is shown when in the assembled state, namely a table configuration. In FIG. 7, only the first panel 12 is deployed together with the leg attachment members 22, 24. In this embodiment, the leg portions 22a, 22b and 24a, 24b of the leg attachment members 22, 24 do have telescoping legs 22a, 22b and 24a, 24b that are telescoped into extended positions so as to dispose or provide the first panel 12 at a table height that is relatively higher than a height at which the first panel 12 is provided in the configurations of FIGS. 1 and 2 or the configuration of FIG. 6. While only a few configurations for the modular panel system 10 are shown in the present disclosure, it is to be appreciated that other configurations could be provided and/or used. For example, the modular panel system 10 could be deployed in a wall configuration wherein the panels 12, 14, 16, 18 are connected together to form a wall structure. Other alternate configurations that could be formed could include a bed configuration, a shelter configuration, etc. For these or other configurations, additional panels (like panels 12, 14, 16, 18) and/or modular panel systems or kits (like system 10) could be added and coupled together and thereby larger configurations could be provided.

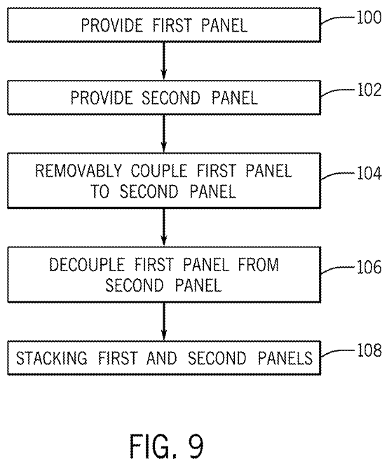

With reference to FIG. 9, a modular panel method will now be described. In particular, the modular panel method will be described with reference to the modular panel system 10, though that is not required and other modular panel systems could be used in place of the modular panel system 10. In the method, at 100, the first panel 12 is provided. The first panel 12, as describe described above, is defined by the first panel edge portions, including first panel end edge portions 12a, 12b spaced apart from one another to define a first panel length, and including first panel lateral edge portions 12c, 12d spaced apart from one another to define the first panel width and each extending from one of the first panel end edge portions 12a to the other to the first panel end edge portion 12b is provided.

At 102, a second panel 14 is provided. The second panel 14, as described above, is defined by a second panel edge portions including second panel end edge portions 14a, 14b spaced apart from one another to define the second panel length, and second panel lateral edge portions 14c, 14d spaced apart from one another to define the second panel width and each extending from one of the second panel end edge portions 14a to the other of the second panel end edge portions 14b. As already described herein, the second panel length is the same as the first panel length and the second panel width is the same as the first panel width. Thus, the first and second panels 12, 14 can be the same size as can be any additional panels included together with the first and second panels 12, 14.

At 104, the first panel 12 is removably coupled to the second panel 14 by having one of the fist panel edge portions 12a disposed longitudinally adjacent one of the second panel edge portions 14a and removably coupling the first panel end edge portion 12a and the second panel end edge portion 14a together to thereby removably couple the first panel 12 to the second panel 14. Optionally, this step 104 can include having the third and four panel 16, 18 provided and removably coupled to the first and second panels 12, 14 in the various configurations discussed hereinabove. Additionally, as shown at 106, the method can include decoupling the first panel 12 from the second panel 14 relative to one another. Optionally, this step 106 can include having the third and fourth panels 16, 18 decoupled from the first and second panels 12, 14 and/or one another. Still further, at 108, the method can include stacking the first panel 12 and the second panel 14 in the lie-flat or stacking configuration relative to one another (for example as shown in FIG. 8). Optionally, this step 108 can include stacking the third and fourth panels 16, 18 in addition to the first and second panels 12, 14.

It will be appreciated that various of the above-disclosed and other features and functions, or alternatives or varieties thereof, may be desirably combined into many other different systems or applications. Also that various presently unforeseen or unanticipated alternatives, modifications, variations, or improvements therein may be subsequently made by those skilled in the art which are also intended to be encompassed by the following claims.

1. A modular panel system, comprising:
a first panel;
a second panel removably connected to the first panel;
wherein each of the first and second panels includes end edge portions spaced apart from one another to define a panel length, and lateral edge portions spaced apart from one another to define a panel width with each of the lateral edge portions extending from one of the end edge portions to the other of the end edge portions,
wherein the panel length and panel width of the second panel are, respectively, the same as the panel length and panel width of the first panel, and
wherein the first and second panels are configured to be removably coupled to one another by having respective edge portions of each of the first and second panels arranged longitudinally adjacent to one another and removably coupled together.

2. The modular panel system of claim 1 further including:
a third panel removably connected to at least one of the first panel and the second panel, the third panel including end edge portions spaced apart from one another to define a panel length of the third panel, and lateral edge portions spaced apart from one another to define a panel width of the third panel with each of the lateral edge portions of the third panel extending from one of the end edge portions of the third panel to the other of the end edge portions of the third panel, wherein the panel length and panel width of the third panel are, respectively, the same as the panel length and panel width of the first panel.

3. The modular panel system of claim 2 further including:
a fourth panel removably connected to at least one of the first panel, the second panel and the third panel, the fourth panel including end edge portions spaced apart from one another to define a panel length of the fourth panel, and lateral edge portions spaced apart from one another to define a panel width of the fourth panel with each of the lateral edge portions of the fourth panel extending from one of the end edge portions of the fourth panel to the other of the end edge portions of the fourth panel, wherein the panel length and panel width of the fourth panel are, respectively, the same as the panel length and panel width of the first panel.

4. The modular panel system of claim 3 wherein the first, second, third and fourth panels are orthogonally arranged to form a rectangular structure, and wherein the end edge portions of first, second, third and fourth panels are secured to one another such that the second and third panels are spaced apart from one another and are secured to both the first and fourth panels with the first and fourth panels spaced apart from one another.

5. The modular panel system of claim 4 wherein the second and third panels extend in a first direction away from the first panel, wherein the modular panel system further includes at least one leg attachment member secured to the first panel and extending in a second direction away from the first panel that is opposite the first direction.

6. The modular panel system of claim 5 wherein the at least one leg attachment member includes a first leg attachment member and a second leg attachment member, wherein the first leg attachment member is secured to a first one of the end edge portions of the first panel and the second leg attachment member is secured to a second one of the end edge portions of the first panel.

7. The modular panel system of claim 6 wherein each of the first and second leg attachment members includes a pair of telescoping legs.

8. The modular panel system of claim 4 further including:
a flexible coupling material member coupled to one of the lateral edge portions of the first panel and coupled to one of the lateral edge portions of the fourth panel.

9. The modular panel system of claim 8 wherein the flexible coupling material member is coupled to a front one of the lateral edge portions of the first panel and is coupled to a rear one of the lateral edge portions of the fourth panel.

10. The modular panel system of claim 4 wherein the fourth panel is removably connected to the second and third panels at edge portions spaced apart from the first panel.

11. The modular panel system of claim 4 wherein the fourth panel is removably connected to only the second panel at an end edge portion of the second panel that is spaced apart from the first panel.

12. The modular panel system of claim 1 wherein each of the first and second panels includes:
a frame defining the end edge portions and the lateral edge portions; and
a flexible material member tautly secured to the frame at each of the end edge portions and each of the lateral edge portions.

13. The modular panel system of claim 12 wherein the frame is a tubular frame defining a panel perimeter.

14. The modular panel system of claim 13 wherein the flexible material member includes sleeve portions for receiving the tubular frame.

15. The modular panel system of claim 1 further including:
a coupling device removably coupling the first and second panels to one another at a desired relative angle.

16. A modular panel system kit, comprising:
a first panel defined by first panel edge portions including first panel end edge portions spaced apart from one another to define a first panel length, and including first panel lateral edge portions spaced apart from one another to define a first panel width and each extending from one of the first panel end edge portions to the other of the first panel end edge portions; and
a second panel defined by second panel edge portions including second panel end edge portions spaced apart from one another to define a second panel length, and including second panel lateral edge portions spaced apart from one another to define a second panel width and each extending from one of the second panel end edge portions to the other of the second panel end edge portions;
wherein the second panel length is the same as the first panel length and the second panel width is the same as the first panel width, and
wherein the first and second panels are configured to be removably coupled to one another by having one of the first panel edge portions disposed longitudinally adjacent one of the second panel edge portions and removably coupled thereto.

17. The modular panel system kit of claim 16 wherein each of the first and second panels includes:
a frame defining the end edge portions and the lateral edge portions; and
a flexible material member tautly secured to the frame each of the end edge portions and each of the lateral edge portions.

18. The modular panel system kit of claim 16 further including:
at least one coupling device for coupling the first and second panels to one another at a desired relative angle; and
at least one leg attachment member including a pair of telescoping legs.

19. A modular panel method, comprising:
providing a first panel defined by first panel edge portions including first panel end edge portions spaced apart from one another to define a first panel length, and including first panel lateral edge portions spaced apart from one another to define a first panel width and each extending from one of the first panel end edge portions to the other of the first panel end edge portions;
providing a second panel defined by second panel edge portions including second panel end edge portions spaced apart from one another to define a second panel length, and including second panel lateral edge portions spaced apart from one another to define a second panel width, and each extending from one of the second panel end edge portions to the other of the second panel end edge portions, wherein the second panel length is the same as the first panel length and the second panel width is the same as the first panel width, and
removably coupling the first panel and the second panel together by having one of the first panel edge portions disposed longitudinally adjacent one of the second panel edge portions and removably coupling the first panel edge portion and the second panel edge portion together.

20. The modular panel method of claim 19 wherein removably coupling the first panel and the second panel to one another includes removably coupling the first and second panels into a use configuration, and wherein the method further includes:
decoupling the first panel and the second panel relative to one another; and
stacking the first panel and the second panel in a lie-flat configuration relative to one another.
